(19) United States
(12) Patent Application Publication
(10) Pub. No.: US 2022/0057079 A1
(43) Pub. Date: Feb. 24, 2022

(54) RECIPROCATING SAW

(71) Applicant: Nanjing Chervon Industry Co., Ltd., Nanjing (CN)

(72) Inventors: Tian Yu, Nanjing (CN); Lai Liu, Nanjing (CN); Keqiong Zhong, Nanjing (CN); Shichun Tao, Nanjing (CN)

(21) Appl. No.: 17/406,156

(22) Filed: Aug. 19, 2021

(30) Foreign Application Priority Data
Aug. 21, 2020 (CN) 202010852062.0

(51) Int. Cl. F21V 33/00; B23D 59/00

(52) U.S. Cl. CPC F21V 33/0084; F21W 2111/00; B23D 59/003

(57) ABSTRACT

A reciprocating saw includes a casing, a clamping mechanism, a bracket, a first light-emitting piece, and a second light-emitting piece. The casing extends in a front-and-rear direction and forms an accommodation space. The clamping mechanism is disposed at least partially in the accommodation space and configured to clamp an operation accessory. The bracket is disposed at least partially on a front side of the clamping mechanism. The first light-emitting piece and the second light-emitting piece are disposed on a front side of the casing. The first light-emitting piece fits with the bracket and the operation accessory so that a cutting indicator line distributed in an extension direction of the operation accessory is formed. The second light-emitting piece fits with the bracket so that a cutting indicator region perpendicular to the cutting indicator line and extending in an up-and-down direction is formed.

### RELATED APPLICATION INFORMATION

This application claims the benefit under 35 U.S.C. § 119(a) of Chinese Patent Application No. CN 202010852062.0, filed on Aug. 21, 2020, which is incorporated by reference in its entirety herein.

### BACKGROUND

A power tool such as a reciprocating saw is used as a cutting tool to cut a workpiece. The reciprocating saw generally includes a reciprocating rod that can be driven to reciprocate at a high speed within a preset range and can be connected to an operation accessory such as a saw blade, so as to cut the workpiece. Some reciprocating saws that can be operated by one hand can be applied to some workpieces located in confined spaces, closed spaces, or dim spaces. However, in the preceding operation environments, the visibility of the workpieces is low so that a user cannot perform cutting accurately.

### SUMMARY

A reciprocating saw is provided. The reciprocating saw includes a casing, a clamping mechanism, a bracket, a first light-emitting piece, and a second light-emitting piece, where the casing extends in a front-and-rear direction and forms an accommodation space; the clamping mechanism is disposed at least partially in the accommodation space and configured to clamp an operation accessory; the bracket is disposed at least partially on a front side of the clamping mechanism; the first light-emitting piece is disposed on a front side of the casing; and the second light-emitting piece is disposed on the front side of the casing. The first light-emitting piece fits with the bracket and the operation accessory so that a cutting indicator line distributed in an extension direction of the operation accessory is formed; and the second light-emitting piece fits with the bracket so that a cutting indicator region perpendicular to the cutting indicator line and extending in an up-and-down direction is formed.

In an example, the bracket is formed with an opening through which at least part of the operation accessory is capable of passing, and light emitted by the first light-emitting piece passes through the opening to form the cutting indicator line.

In an example, the bracket blocks at least part of light emitted by the second light-emitting piece so that the cutting indicator region is formed.

In an example, light emitted by the first light-emitting piece and light emitted by the second light-emitting piece further include an overlapping region, where the overlapping region is located on a side of the bracket facing towards the casing.

In an example, the bracket includes a connection portion extending at least partially in a direction of a first straight line and a support portion configured to be in contact with a workpiece, and the first light-emitting piece extends in a direction of a second straight line, where the second straight line obliquely intersects with the first straight line, and an acute angle between the second straight line and the first straight line is greater than or equal to 20° and less than or equal to 50°.

In an example, the bracket includes a connection portion extending at least partially in a direction of a first straight line and a support portion configured to be in contact with a workpiece, and the second light-emitting piece extends in a direction of a third straight line, where the third straight line obliquely intersects with the first straight line, and an acute angle between the third straight line and the first straight line is greater than or equal to 5° and less than or equal to 20°.

In an example, the bracket includes a connection portion extending at least partially in a direction of a first straight line and a support portion configured to be in contact with a workpiece; the first light-emitting piece extends in a direction of a second straight line, where the second straight line obliquely intersects with the first straight line, and an acute angle between the second straight line and the first straight line is greater than or equal to 30° and less than or equal to 40°; and the second light-emitting piece extends in a direction of a third straight line, where the third straight line obliquely intersects with the first straight line, and an acute angle between the third straight line and the first straight line is greater than or equal to 10° and less than or equal to 20°.

In an example, a circuit board is further included, where the first light-emitting piece and the second light-emitting piece are connected in series and electrically connected to the circuit board.

In an example, the bracket includes a connection portion extending at least partially in a direction of a first straight line and a support portion configured to be in contact with a workpiece; the first light-emitting piece extends in a direction of a second straight line, where the second straight line obliquely intersects with the first straight line; and the second light-emitting piece extends in a direction of a third straight line, where the third straight line obliquely intersects with the first straight line; wherein an acute angle between the second straight line and the first straight line is greater than an acute angle between the third straight line and the first straight line.

In an example, the first light-emitting piece is disposed on an upper side of the clamping mechanism, and the second light-emitting piece is disposed on a lower side of the clamping mechanism.

In an example, the reciprocating saw further includes a reciprocating rod, where the clamping mechanism is installed on the reciprocating rod, the first light-emitting piece is disposed on an upper side of the reciprocating rod, and the second light-emitting piece is disposed on a lower side of the reciprocating rod.

In an example, the first light-emitting piece and the second light-emitting piece are separately disposed.

In an example, a distance between the first light-emitting piece and the second light-emitting piece is greater than or equal to 45 mm and less than or equal to 60 mm.

A reciprocating saw is provided. The reciprocating saw includes a casing, a clamping mechanism, a bracket, a first light-emitting piece, and a second light-emitting piece, where the casing extends in a front-and-rear direction and forms an accommodation space; the clamping mechanism is disposed at least partially in the accommodation space and configured to clamp an operation accessory; the bracket is disposed at least partially on a front side of the clamping mechanism; the first light-emitting piece is disposed on a front side of the casing; and the second light-emitting piece is disposed on the front side of the casing. The first light-emitting piece and the second light-emitting piece fit with the bracket and the operation accessory so that a cutting indicator line distributed in an extension direction of the operation accessory is formed.

A reciprocating saw is provided. The reciprocating saw includes a casing, a clamping mechanism, a bracket, a first light-emitting piece, and a second light-emitting piece, where the casing extends in a front-and-rear direction and forms an accommodation space; the clamping mechanism is disposed at least partially in the accommodation space and configured to clamp an operation accessory; the bracket is disposed at least partially on a front side of the clamping mechanism; the first light-emitting piece is disposed on a front side of the casing; and the second light-emitting piece is disposed on the front side of the casing. The first light-emitting piece and the second light-emitting piece fit with the bracket so that a cutting indicator region extending in an up-and-down direction is formed.

The beneficial effect of the present disclosure is that fitting with the bracket is achieved so that not only lighting can be provided but also the cutting indicator line and the cutting indicator region can be formed, thereby effectively improving cutting accuracy and operation experience.

### BRIEF DESCRIPTION OF DRAWINGS

FIG. 1 is a perspective view of a reciprocating saw;

FIG. 2 is a plan view of a partial structure of light emitted by a first light-emitting piece of the reciprocating saw of FIG. 1;

FIG. 3 is a plan view of a partial structure of light emitted by a second light-emitting piece of the reciprocating saw of FIG. 1;

FIG. 4 is a view of light-emitting regions of a first light-emitting piece and a second light-emitting piece;

FIG. 5 is a top view of the reciprocating saw of FIGS. 1; and

FIG. 6 is a sectional view of the reciprocating saw of FIG. 1.

### DETAILED DESCRIPTION

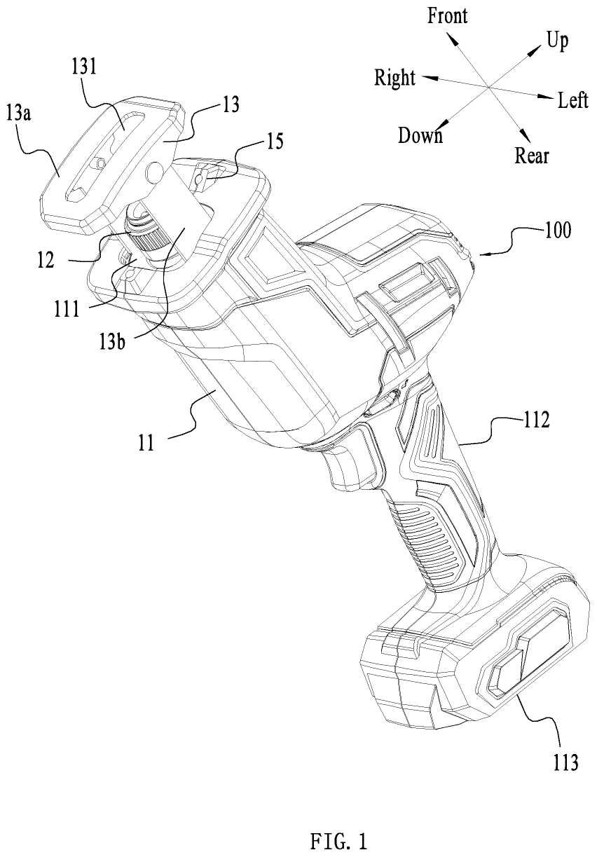

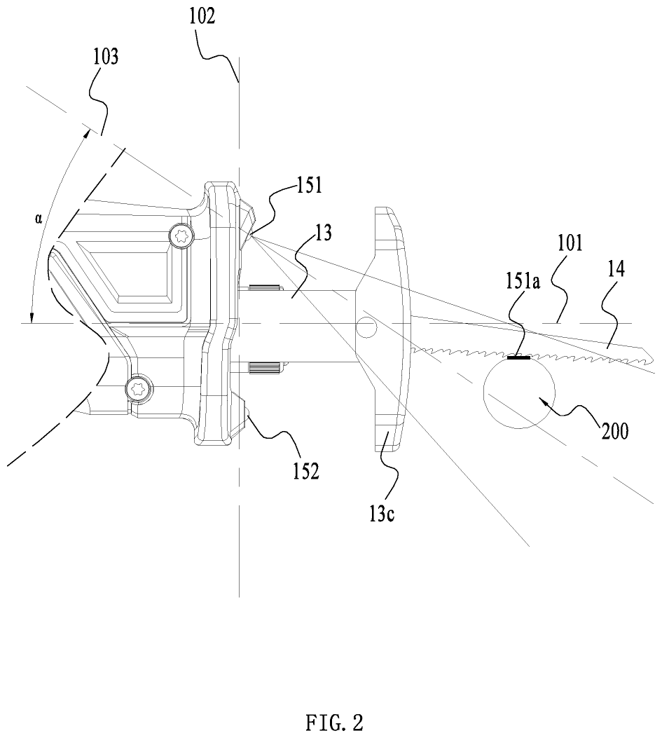

A reciprocating saw 100 shown in FIG. 1 includes a casing 11, a clamping mechanism 12, and a bracket 13. As shown in FIGS. 1 and 2, the casing 11 extends basically in a front-and-rear direction and forms an accommodation space 111, a power mechanism, a transmission mechanism, a control mechanism, and an output assembly are all disposed in the accommodation space 111, and the transmission mechanism connects the power mechanism to the output assembly and is configured to transmit power of the power mechanism to the output assembly to output a reciprocating torque. The casing 11 is further formed with a holding portion 112 for holding and a coupling portion 113 configured to be connected to a power supply assembly (not shown in the figure). The clamping mechanism 12 is connected to the output assembly and configured to clamp an operation accessory 14. The clamping mechanism 12 is disposed at least partially in the accommodation space 111. It is to be understood that the output assembly may extend partially from the accommodation space 111, and at this time, the clamping mechanism 12 connected to the output assembly is disposed outside the accommodation space 111. In the case where the clamping mechanism 12 is connected to the output assembly, the clamping mechanism 12 may be regarded as a part of the output assembly. At this time, it is to be understood that the clamping mechanism 12 is disposed at least partially in the accommodation space 111. As shown in FIGS. 1 and 2, in this example, the clamping mechanism 12 may be configured to clamp a saw blade, where the saw blade can be driven by the output assembly to reciprocate to cut a workpiece 200. For example, saw blades of different materials or structures may be installed so that the reciprocating saw 100 cuts a wood strip, a plastic pipe, and a steel pipe.

The bracket 13 is disposed on a front side of the casing 11 and configured to fit with the workpiece 200. The bracket 13 is provided with a contact surface 13a configured to be in contact with the workpiece 200. The bracket 13 is disposed on a front side of the clamping mechanism 12, and the bracket 13 includes a connection portion 13b extending basically in a direction of a first straight line 101 parallel to an extension direction of the output assembly and a support portion 13c provided with the contact surface 13a. The bracket 13 is provided with an opening 131 through which the operation accessory 14 is capable of passing. In the case where a user operates the reciprocating saw 100, the operation accessory 14 cuts the workpiece 200 and extends into the workpiece 200; at this time, the bracket 13 may be configured to abut against the workpiece 200 to provide support for the user in a cutting process.

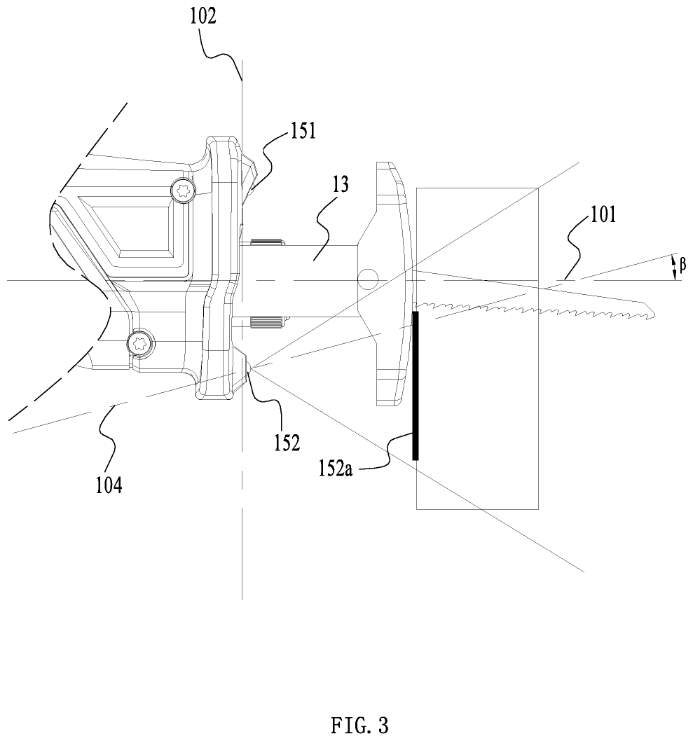

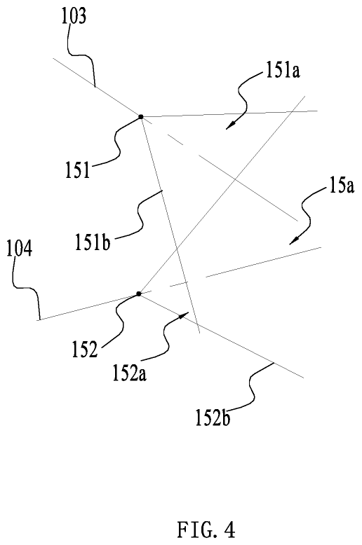

As shown in FIGS. 1 to 4, in this example, the reciprocating saw 100 has a relatively small volume and thus can be operated by the user with one hand to cut the workpiece 200 in a narrow or dark position. In the case where the workpiece 200 in the dark position is cut, the visibility and cutting accuracy of the workpiece 200 cannot be ensured due to an effect of a cutting environment. Therefore, this example further provides a light-emitting assembly 15 that is capable of improving the visibility and the cutting accuracy. Specifically, the light-emitting assembly 15 includes a first light-emitting piece 151 and a second light-emitting piece 152. The casing 11 further includes an extension plane 102 perpendicular to the direction of the first straight line 101, and the clamping mechanism 12 is configured to pass through the extension plane 102. The light-emitting assembly 15 is disposed at least partially in the extension plane 102. The extension plane 102 basically forms a front end surface of the casing 11. The first light-emitting piece 151 is disposed at an upper position of the casing 11 in the extension plane 102, and the second light-emitting piece 152 is disposed at a lower position of the casing 11 in the extension plane 102. The first light-emitting piece 151 is disposed on an upper side of the clamping mechanism 12, and the second light-emitting piece 152 is disposed on a lower side of the clamping mechanism 12.

In this example, both the first light-emitting piece 151 and the second light-emitting piece 152 are configured to be LED lights. It is to be understood that the first light-emitting piece 151 and the second light-emitting piece 152 may be configured as point light sources, surface light sources, or other lighting and light-emitting devices, which is not repeated herein. In a direction of a preset straight line extending in a left-and-right direction and in a preset plane perpendicular to the preset straight line, a projection of light emitted by the first light-emitting piece 151 and light emitted by the second light-emitting piece 152 on the preset plane in the direction of the preset straight line is basically fan-shaped. As shown in FIGS. 2 to 4, a light-emitting region 151a of the first light-emitting piece 151 in a vertical plane extending up and down is basically an angled region, and a light-emitting region 152a of the second light-emitting piece 152 in the vertical plane extending up and down is basically an angled region. In this manner, the light emitted by the first light-emitting piece 151 and the light emitted by the second light-emitting piece 152 can be more concentrated. The first light-emitting piece 151 fits with the bracket 13 and the operation accessory 14 so that a cutting indicator line 151a distributed in an extension direction of the operation accessory 14 is formed; the second light-emitting piece 152 fits with the bracket so that a cutting indicator region 152a perpendicular to the cutting indicator line 151a and extending in an up-and-down direction is formed. Specifically, the light emitted by the first light-emitting piece 151 is blocked at least partially by the operation accessory 14 after passing through the opening 131 on the bracket 13 so that a shadow located on a lower side of the operation accessory 14 and distributed basically in the direction of the first straight line 101 is formed, where the shadow may be used as the cutting indicator line 151a for guiding the user to cut. After the light emitted by the second light-emitting piece 152 passes through the opening 131 on the bracket 13 and an outer edge of the bracket 13, the cutting indicator region 152a distributed in the up-and-down direction is formed, where the cutting indicator region 152a is capable of effectively illuminating a cutting line distributed on the workpiece 200 along the up-and-down direction. It is to be understood that both the cutting indicator line 151a and the cutting indicator region 152a exist without interfering with each other. In the case where the user operates with reference to the cutting indicator line 151a, the light emitted by the second light-emitting piece 152 may be used as auxiliary lighting so that the visibility of a region to be cut is significantly improved, the user experience is improved, the cutting accuracy is effectively improved, and the user is prevented from separately adding a lighting device. In the case where the user operates with reference to the cutting indicator region 152a, the light emitted by the first light-emitting piece 151 may be used as auxiliary lighting so that the visibility of the region to be cut is significantly improved, the user experience is improved, the cutting accuracy is effectively improved, and the user is prevented from separately adding the lighting device. In addition, the light emitted by the first light-emitting piece 151 and the light emitted by the second light-emitting piece 152 further include an overlapping region 15a, where the overlapping region is optionally disposed on a side of the bracket 13 facing towards the casing 11 so that the first light-emitting piece 151 and the second light-emitting piece 152 fit with each other, thus achieving better lighting and indication effects. As an implementation manner, the cutting indicator line 151a and the cutting indicator region 152a are separately disposed in two planes. For some workpieces 200 with relatively complex structures and with different reference lines on different planes, the preceding configuration enables workpieces 200 to be cut to be accurately cut in a more three-dimensional manner. In some optional examples, the cutting indicator line and the cutting indicator region are disposed in the same plane. For some workpieces 200 with more regular structures, the preceding configuration enables workpieces 200 to be cut to be accurately cut in a more reliable manner.

More specifically, the first light-emitting piece 151 extends basically in a direction of a second straight line 103, where the second straight line 103 obliquely intersects with the first straight line 101. It is to be understood that the second straight line 103 may be understood as a center line of the light-emitting region 151a of the first light-emitting piece 151, that is, the light-emitting region 151a of the first light-emitting piece 151 is an angled region with the first light-emitting piece 151 as a vertex and two edges 151b passing through the vertex as sides, and the center line is a median of the angled region. That is, the second straight line 103 is the median of the angled region. An acute angle a between the first straight line 101 and the second straight line 103 is greater than or equal to 20° and less than or equal to 50°. Preferably, the acute angle a between the first straight line 101 and the second straight line 103 is configured to be greater than or equal to 30° and less than or equal to 40°. In this manner, the light emitted by the first light-emitting piece 151 can pass through the opening 131 on the bracket 13 to the maximum and irradiate the operation accessory 14 so that the relatively clear cutting indicator line 151a can be formed, both sides of the operation accessory 14 are irradiated by relatively strong light, the workpiece 200 is illuminated, and thus the visibility of the region to be cut is effectively improved. In addition, the light emitted by the first light-emitting piece 151 and the light emitted by the second light-emitting piece 152 are more concentrated on the premise that no interference is generated so that the following case can be avoided: the light is scattered, resulting in a poor lighting effect.

The second light-emitting piece 152 extends basically in a direction of a third straight line 104, where the third straight line 104 obliquely intersects with the first straight line 101. It is to be understood that the third straight line 104 may be understood as a center line of the light-emitting region 152a of the second light-emitting piece 152, that is, the light-emitting region 152a of the second light-emitting piece 152 is an angled region with the second light-emitting piece 152 as a vertex and two edges 152b passing through the vertex as sides, and the center line is a median of the angled region. That is, the third straight line 104 is the median of the angled region. An acute angle β between the first straight line 101 and the third straight line 104 is greater than or equal to 5° and less than or equal to 30°. Preferably, the acute angle β between the first straight line 101 and the third straight line 104 is configured to be greater than or equal to 10° and less than or equal to 20°. In this manner, the light emitted by the second light-emitting piece 152 can pass through the bracket 13 to the maximum and irradiate the operation accessory 14 so that the relatively clear cutting indicator region 152a with relatively high visibility can be formed. In fact, an intensity of light on the cutting indicator region 152a is also positively correlated to a distance between the bracket 13 and the preceding extension plane 102. Specifically, in the case where the distance between the bracket 13 and the extension plane 102 is less than a preset distance, the light emitted by the second light-emitting piece 152 is blocked to a relatively large extent so that the clarity and visibility of the cutting indicator region 152a are relatively low. In the case where the distance between the bracket 13 and the extension plane 102 is greater than a preset value, more of the light emitted by the second light-emitting piece 152 can pass through the bracket 13 so that the clarity and visibility of the cutting indicator region 152a are relatively high, and it is convenient for the user to operate.

It is to be understood that the reciprocating saw 100 provided in this example includes two cutting indicator manners. In the case where the workpiece 200 extending in the up-and-down direction is cut, a cutting line of the workpiece 200 extending in the up-and-down direction can be clearly seen through an indication function of the cutting indicator region 152a. In addition, in the case where the workpiece 200 such as a cylinder with a relatively small radial dimension and a cutting line distributed basically in the front-and-rear direction needs to be cut, a cutting line distributed in the front-and-rear direction can be clearly illuminated through the indication function of the cutting indicator line 151a, or cutting is performed according to the cutting indicator line 151a formed by the first light-emitting piece 151, bringing great convenience to the operation of the user.

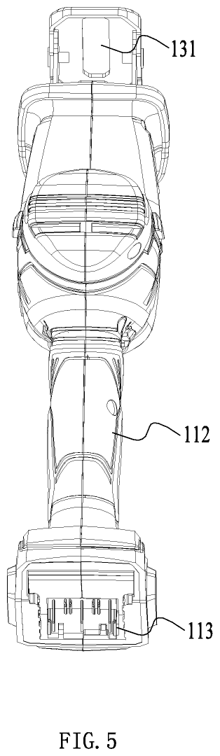

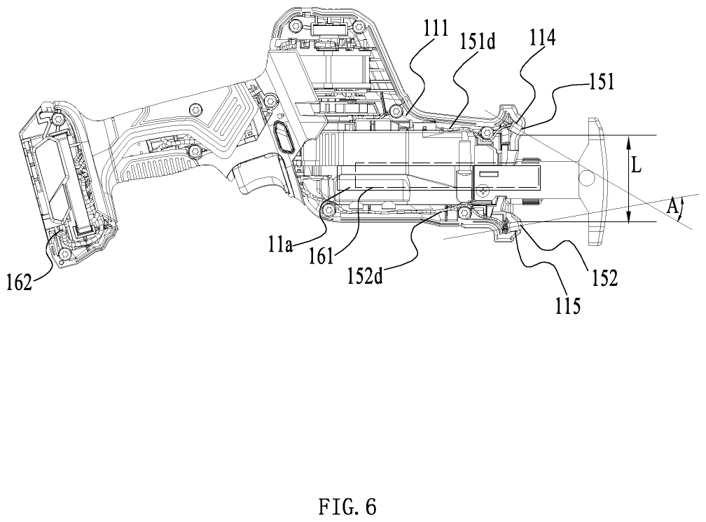

As shown in FIGS. 5 and 6, the casing 11 is formed with a first accommodation cavity 114 configured to install and accommodate the first light-emitting piece 151 and a second accommodation cavity 115 configured to install and accommodate the second light-emitting piece 152. The first accommodation cavity 114 extends basically in the direction of the second straight line 103, and the second accommodation cavity 115 extends basically in the direction of the third straight line 104. In fact, the first accommodation cavity 114 can be disposed within the acute angle between the second straight line 103 and the first straight line 101 that obliquely intersect with each other, and the second accommodation cavity 115 can be disposed within the acute angle between the third straight line 104 and the first straight line 101 that obliquely intersect with each other. The first light-emitting piece 151 and the second light-emitting piece 152 are connected in series and electrically connected to the power supply assembly. In the case where the reciprocating saw 100 is in a dim environment or an environment with relatively low visibility, the control mechanism may be operated to turn on the light-emitting assembly 15. At this time, the first light-emitting piece 151 and the second light-emitting piece 152 can simultaneously illuminate the region to be cut and the cutting indicator line 151a and the cutting indicator region 152a can be formed.

The output assembly includes a reciprocating rod 161, and the clamping mechanism 12 is installed on the reciprocating rod 161. The first light-emitting piece 151 is disposed on an upper side of the reciprocating rod 161, and the second light-emitting piece 152 is disposed on a lower side of the reciprocating rod 161. An angle A between the second straight line 103 and the third straight line 104 that obliquely intersect with each other is also an acute angle, and the angle A between the second straight line 103 and the third straight line 104 that obliquely intersect with each other is greater than or equal to 20 degrees and less than or equal to 60 degrees. In this manner, the first light-emitting piece 151 and the second light-emitting piece 152 irradiate a more concentrated range so that a light-emitting intensity is improved.

The acute angle a between the first straight line 101 and the second straight line 103 is greater than the acute angle β between the first straight line 101 and the third straight line 104 so that the first light-emitting piece 151 and the second light-emitting piece 152 concentrate light on the workpiece 200 located on the lower side of the operation accessory 14.

The reciprocating saw 100 further includes a first wire 151d, a second wire 152d, and a circuit board 162, where the first wire 151d is connected to the first light-emitting piece 151, and the second wire 152d is connected to the second light-emitting piece 152. The first light-emitting piece 151 is electrically connected to the circuit board 162 through the first wire 151d, and the second light-emitting piece 152 is electrically connected to the circuit board 162 through the second wire 152d. The circuit board 162 is connected to a power supply device to supply power to the first light-emitting piece 151 and the second light-emitting piece 152. The first light-emitting piece 151 and the second light-emitting piece 152 are disposed separately, and a distance between the first light-emitting piece 151 and the second light-emitting piece 152 is greater than or equal to 45 mm and less than or equal to 60 mm. The reciprocating saw 100 further includes an inner casing 11a, where the inner casing 11a is disposed in the casing 11, a transmission assembly is disposed in the inner casing 11a, and the reciprocating rod 161 is disposed at least partially in the inner casing 11a. The first wire 151d is disposed at least partially on an upper side of the inner casing 11a, and the second wire 152d is disposed at least partially on a lower side of the inner casing 11a. That is, the first wire 151d extends from the upper side of the inner casing 11a to the circuit board 162, and the second wire 152d extends from the lower side of the inner casing 11a to the circuit board 162.

The above illustrates and describes basic principles, main features, and advantages of the present disclosure. It is to be understood by those skilled in the art that the preceding examples do not limit the present disclosure in any form, and technical solutions obtained by means of equivalent substitution or equivalent transformation fall within the scope of the present disclosure.

What is claimed is:

1. A reciprocating saw, comprising:
a casing extending in a front-and-rear direction and forming an accommodation space;
a clamping mechanism disposed at least partially in the accommodation space and configured to clamp an operation accessory;
a bracket disposed at least partially on a front side of the clamping mechanism;
a first light-emitting piece disposed on a front side of the casing; and
a second light-emitting piece disposed on the front side of the casing;
wherein the first light-emitting piece fits with the bracket and the operation accessory so that a cutting indicator line distributed in an extension direction of the operation accessory is formed, and the second light-emitting piece fits with the bracket so that a cutting indicator region perpendicular to the cutting indicator line and extending in an up-and-down direction is formed.

2. The reciprocating saw of claim 1, wherein the bracket is formed with an opening through which at least part of the operation accessory is capable of passing and light emitted by the first light-emitting piece passes through the opening to form the cutting indicator line.

3. The reciprocating saw of claim 1, wherein the bracket blocks at least part of light emitted by the second light-emitting piece so that the cutting indicator region is formed.

4. The reciprocating saw of claim 1, wherein light emitted by the first light-emitting piece and light emitted by the second light-emitting piece further comprise an overlapping region located on a side of the bracket facing towards the casing.

5. The reciprocating saw of claim 1, wherein the bracket comprises a connection portion extending at least partially in a direction of a first straight line and a support portion configured to be in contact with a workpiece, the first light-emitting piece extends in a direction of a second straight line, the second straight line obliquely intersects with the first straight line, and an acute angle between the second straight line and the first straight line is greater than or equal to 20° and less than or equal to 50°.

6. The reciprocating saw of claim 1, wherein the bracket comprises a connection portion extending at least partially in a direction of a first straight line and a support portion configured to be in contact with a workpiece, the second light-emitting piece extends in a direction of a third straight line, the third straight line obliquely intersects with the first straight line, and an acute angle between the third straight line and the first straight line is greater than or equal to 5° and less than or equal to 20°.

7. The reciprocating saw of claim 1, wherein the bracket comprises a connection portion extending at least partially in a direction of a first straight line and a support portion configured to be in contact with a workpiece, the first light-emitting piece extends in a direction of a second straight line, the second straight line obliquely intersects with the first straight line, an acute angle between the second straight line and the first straight line is greater than or equal to 30° and less than or equal to 40°, the second light-emitting piece extends in a direction of a third straight line, the third straight line obliquely intersects with the first straight line, and an acute angle between the third straight line and the first straight line is greater than or equal to 10° and less than or equal to 20°.

8. The reciprocating saw of claim 1, further comprising a circuit board, wherein the first light-emitting piece and the second light-emitting piece are connected in series and electrically connected to the circuit board.

9. The reciprocating saw of claim 1, wherein the bracket comprises a connection portion extending at least partially in a direction of a first straight line and a support portion configured to be in contact with a workpiece, the first light-emitting piece extends in a direction of a second straight line, the second straight line obliquely intersects with the first straight line, the second light-emitting piece extends in a direction of a third straight line, the third straight line obliquely intersects with the first straight line, and an acute angle between the second straight line and the first straight line is greater than an acute angle between the third straight line and the first straight line.

10. The reciprocating saw of claim 1, wherein the first light-emitting piece is disposed on an upper side of the clamping mechanism and the second light-emitting piece is disposed on a lower side of the clamping mechanism.

11. The reciprocating saw of claim 1, further comprising a reciprocating rod, the clamping mechanism is installed on the reciprocating rod, the first light-emitting piece is disposed on an upper side of the reciprocating rod, and the second light-emitting piece is disposed on a lower side of the reciprocating rod.

12. The reciprocating saw of claim 1, wherein the first light-emitting piece and the second light-emitting piece are separately disposed.

13. The reciprocating saw of claim 1, wherein a distance between the first light-emitting piece and the second light-emitting piece is greater than or equal to 45 mm and less than or equal to 60 mm.

14. A reciprocating saw, comprising:
a casing extending in a front-and-rear direction and forming an accommodation space;
a clamping mechanism disposed at least partially in the accommodation space and configured to clamp an operation accessory;
a bracket disposed at least partially on a front side of the clamping mechanism;
a first light-emitting piece disposed on a front side of the casing; and
a second light-emitting piece disposed on the front side of the casing;
wherein the first light-emitting piece and the second light-emitting piece fit with the bracket and the operation accessory so that a cutting indicator line distributed in an extension direction of the operation accessory is formed.

15. The reciprocating saw of claim 14, wherein the first light-emitting piece is disposed on an upper side of the clamping mechanism and the second light-emitting piece is disposed on a lower side of the clamping mechanism.

16. The reciprocating saw of claim 14, further comprising a reciprocating rod, the clamping mechanism is installed on the reciprocating rod, the first light-emitting piece is disposed on an upper side of the reciprocating rod, and the second light-emitting piece is disposed on a lower side of the reciprocating rod.

17. The reciprocating saw of claim 14, wherein the first light-emitting piece and the second light-emitting piece are separately disposed.

18. The reciprocating saw of claim 14, wherein a distance between the first light-emitting piece and the second light-emitting piece is greater than or equal to 45 mm and less than or equal to 60 mm.

19. A reciprocating saw, comprising:
a casing extending in a front-and-rear direction and forming an accommodation space;
a clamping mechanism disposed at least partially in the accommodation space and configured to clamp an operation accessory;
a bracket disposed at least partially on a front side of the clamping mechanism;
a first light-emitting piece disposed on a front side of the casing; and
a second light-emitting piece disposed on the front side of the casing;
wherein the first light-emitting piece and the second light-emitting piece fit with the bracket so that a cutting indicator region extending in an up-and-down direction is formed.

20. The reciprocating saw of claim 19, wherein the first light-emitting piece is disposed on an upper side of the clamping mechanism and the second light-emitting piece is disposed on a lower side of the clamping mechanism.
